(19) United States
(12) Patent Application Publication
(10) Pub. No.: US 2007/0087261 A1
(43) Pub. Date: Apr. 19, 2007

(54) Membrane-electrode assembly for polymer electrolyte fuel cell

(75) Inventors: Eiji Endoh, Chiyoda-ku (JP); Yoshitaka Doi, Chiyoda-ku (JP); Shinji Terazono, Chiyoda-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY LIMITED, Chiyoda-ku (JP)

(21) Appl. No.: 11/541,636

(22) Filed: Oct. 3, 2006

(30) Foreign Application Priority Data
Oct. 17, 2005 (JP) 2005-301752

(51) Int. Cl. H01M 4/92; H01M 4/96

(52) U.S. Cl. 429/44; 429/42

(57) ABSTRACT

A membrane-electrode assembly for a polymer electrolyte fuel cell, which comprises an anode and a cathode each having a catalyst layer containing a catalyst powder and an ion exchange resin, and an electrolyte membrane made of an ion exchange membrane disposed between the anode and the cathode, characterized in that the catalyst layer of the anode contains a catalyst powder having a platinum-cobalt alloy supported on a carbon carrier.

### BACKGROUND OF THE INVENTION

1. Field of the Invention

The present invention relates to a membrane-electrode assembly for a polymer electrolyte fuel cell, whereby a high output voltage can be obtained over a long period of time.

2. Discussion of Background

A fuel cell is an electric cell whereby a reaction energy of a gas as a feed material is converted directly to electric energy, and a hydrogen-oxygen fuel cell presents no substantial effect to the global environment since its reaction product is only water in principle. Especially, a polymer electrolyte fuel cell employing a polymer membrane as an electrolyte, can be operated at room temperature to provide a high power density, as a polymer electrolyte membrane having high ion conductivity has been developed, and thus is expected to be a prospective power source for mobile vehicles such as electric cars or for small cogeneration systems, along with an increasing social demand for an energy or global environmental problem in recent years.

In a polymer electrolyte fuel cell, a proton conductive ion exchange membrane is commonly employed as an electrolyte, and an ion exchange membrane made of a perfluorocarbon polymer having sulfonic acid groups, is particularly excellent in the basic properties. In the polymer electrolyte fuel cell, gas diffusion type electrode layers are disposed on both sides of the ion exchange membrane, and power generation is carried out by supplying a gas containing hydrogen as a fuel and a gas (such as air) containing oxygen as an oxidizing agent to the anode and the cathode, respectively.

In the reduction reaction of oxygen at the cathode of the polymer electrolyte fuel cell, the reaction proceeds via hydrogen peroxide (H₂O₂), and it is worried that the electrolyte membrane may be deteriorated by the hydrogen peroxide or peroxide radicals to be formed in the catalyst layer. Further, to the anode, oxygen molecules will come from the cathode through the membrane, and it is conceivable that at the anode, hydrogen molecules and oxygen molecules will undergo a reaction to form hydrogen peroxide or peroxide radicals. Especially when a hydrocarbon membrane is used as the electrolyte membrane, it is poor in the stability against radicals, which used to be a serious problem in an operation for a long period of time. For example, the first practical use of a polymer electrolyte fuel cell was when it was adopted as a power source for a Gemini space ship in U.S.A., and at that time, a membrane having a styrene/divinylbenzene polymer sulfonated, was used as an electrolyte membrane, but it had a problem in the durability over a long period of time. As opposed to such a hydrocarbon type polymer, the above-described perfluorocarbon polymer having sulfonic acid groups has been known to be excellent in the stability against radicals.

In recent years, a demand for practical use of a polymer electrolyte fuel cell as a power source for e.g. automobiles or housing markets is increasing, and its developments are accelerated. In such applications, its operation with high efficiency is required. Accordingly, its operation at a higher voltage is desired, and at the same time, cost reduction is desired. Further, in order to secure electroconductivity of the electrolyte membrane, it is required to humidify the electrolyte membrane, but from the viewpoint of the efficiency of the entire fuel cell system, an operation under low or no humidification is required in many cases. It has been reported that under such operation conditions, even an ion exchange membrane comprising a perfluorocarbon polymer having sulfonic acid groups excellent in the stability against radicals will be deteriorated, and that this deterioration is caused by hydrogen peroxide or peroxide radicals formed in the catalyst layer (A. B. LaConti, M. Hamadan and R. C. McDonald, “Mechanisms of Membrane Degradation for PEMFCs” Handbook of Fuel Cells: Fundamentals, Technology, and Applications, P651, Vol 3, W. Vielstich, A. Lamm, and H. A. Gasteige, Editors, Wiley, New York, NY, 2003).

Further, in order to overcome the above problem of the durability, a technique of incorporating a compound with a phenolic hydroxyl group or a transition metal oxide capable of catalytically decomposing peroxide radicals to the electrolyte membrane (JP-A-2001-118591) or a technique of supporting catalytic metal particles in the electrolyte membrane to decompose hydrogen peroxide (JP-A-06-103992) is also disclosed. However, such a technique is a technique of incorporating a material only to the electrolyte membrane, and is not one attempted to improve the catalyst layer as the source for generating hydrogen peroxide or peroxide radicals. Accordingly, although at the initial stage, the effect for improvement was observed, there was a possibility that a serious problem would result in the durability over a long period of time. Further, there was a problem that the cost tended to be high.

### SUMMARY OF THE INVENTION

Under these circumstances, for the practical application of a polymer electrolyte fuel cell to e.g. vehicles or housing markets, it is an object of the present invention to provide a membrane-electrode assembly for a polymer electrolyte fuel cell, whereby power generation with sufficiently high energy efficiency is possible and at the same time, excellent durability can be obtained over a long period of time.

Further, it is an object of the present invention to provide a membrane-electrode assembly for a polymer electrolyte fuel cell, which has a high power generation performance and whereby constant power generation is possible over a long period of time, either in its operation under low or no humidification where the humidification temperature of the feed gas is lower than the cell temperature or in its operation under high humidification where humidification is carried out at a temperature close to the cell temperature.

In order to achieve the above objects, the present inventors have conceived to suppress conversion of oxygen molecules which came from the cathode through the membrane into hydrogen peroxide in the anode, and conducted studies particularly on the anode. As a result, they have found that the durability over a long period of time is improved by use of a catalyst powder having a platinum-cobalt alloy supported on a carbon carrier, as the catalyst powder of the anode, and accomplished the present invention.

The present invention provides a membrane-electrode assembly for a polymer electrolyte fuel cell, which comprises an anode and a cathode each having a catalyst layer containing a catalyst powder and an ion exchange resin, and an electrolyte membrane made of an ion exchange membrane disposed between the anode and the cathode, characterized in that the catalyst layer of the anode contains a catalyst powder having a platinum-cobalt alloy supported on a carbon carrier.

The membrane-electrode assembly of the present invention provides a high energy efficiency and is excellent in the durability over a long period of time. Further, it is excellent in the durability either in its operation under low or no humidification or in its operation under high humidification, regardless of the conditions of humidification of the feed gas.

### DETAILED DESCRIPTION OF THE PREFERRED EMBODIMENTS

In the membrane-electrode assembly of the present invention, the catalyst layer of the anode contains a catalyst powder having a platinum-cobalt alloy supported on a carbon carrier. By such a construction, the membrane-electrode assembly of the present invention is excellent in the durability. The reason why such an effect is obtained is not necessarily clear, but is considered as follows.

In the electrochemical reduction reaction of oxygen on a platinum electrode supported on a carbon carrier, when the electrode potential to the standard hydrogen electrode is from +0.2 V to +0.5 V, 99 to 99.5% of oxygen to be reduced is reduced to water molecules in a four-electron step, and the other 0.5 to 1% is reduced to hydrogen peroxide in a two-electron step. Further, when the electrode potential is at least +0.6 V, almost 100% is reduced to water molecules in a four-electron step. On the other hand, it has been reported that when the electrode potential is at most +0.1 V, i.e. at an electrode potential corresponding to the anode of a fuel cell, about 6% of oxygen to be reduced is reduced to hydrogen peroxide (Journal of Electroanalytical Chemistry, 495(2001) p140).

Further, prior art discloses use of a platinum-cobalt alloy catalyst as the cathode catalyst (Japanese Patent No. 3643552), and a platinum-cobalt alloy is known to have a higher oxygen reduction performance than platinum.

Accordingly, the present inventors have conceived as follows. Namely, in electrochemical reduction of oxygen atoms which came from the cathode through the membrane on the anode, hydrogen peroxide (H₂O₂) as a reaction intermediate will be formed in a large amount on a platinum electrode, whereas on a platinum-cobalt alloy catalyst having a higher oxygen reduction performance than the platinum catalyst, the oxygen molecules will more readily be reduced to water molecules. If so, it is considered that, formation of hydrogen peroxide on the anode will be suppressed, and as a result, deterioration of the electrolyte membrane will be remarkably suppressed.

As described in after-mentioned Examples, in an open circuit voltage test, there is a significant difference in the durability between a case where a platinum-cobalt alloy catalyst is used for the anode and a case where it is used for the cathode, and very excellent durability will be achieved when it is used for the anode as compared with a case where a platinum catalyst is used.

In the present invention, the molar ratio of platinum to cobalt in the platinum-cobalt alloy contained in the catalyst layer of the anode is preferably from 6:1 to 2:1. If the molar ratio of platinum to cobalt is out of this range, the oxygen reduction power will decrease, and the effect of suppressing formation of hydrogen peroxide on the anode may be small. The molar ratio is more preferably from 5:1 to 3:1.

Further, the amount of platinum atoms (platinum contained in the platinum-cobalt alloy) in the catalyst layer of the anode is preferably from 0.05 to 5 mg/cm² per apparent surface area. If the. amount of platinum is smaller than this range, the oxidation reaction of hydrogen tends to be slow, and the properties may be deteriorated. Further, if the amount is larger than this range, the properties will not be improved, but the cost tends to increase. It is more preferably from 0.07 to 2 mg/cm².

The carbon carrier to be used for the catalyst for the anode is preferably at least one member selected from the group consisting of carbon black, activated carbon, carbon nanotubes and carbon nanohorns. Further, the specific surface area of the carbon carrier is preferably from 30 to 1,000 m²/g, more preferably from 50 to 800 m²/g. If the specific surface area of the carbon carrier is too small, a predetermined amount of the platinum-cobalt alloy cannot be supported, and as a result, the catalyst layer will be thick when a predetermined amount of the platinum-cobalt alloy is made to be present in the catalyst layer, whereby diffusion of the reaction substance will be inhibited, and the properties may be deteriorated.

Further, if the specific surface area of the carbon carrier is too large, since a large number of fine pores is present in the carbon carrier, the platinum-cobalt alloy will be supported in the interior of the fine pores of the carbon carrier and as a result, when the catalyst is covered with an ion exchange resin to form the catalyst layer, the platinum-cobalt alloy supported in the interior of the fine pores of the carbon carrier may not sufficiently be covered with the ion exchange resin. Therefore, in the operation of a fuel cell, the platinum-cobalt alloy cannot be operated as the electrode catalyst, that is, the efficiency of the electrode catalyst may be low.

Since in the catalyst layer of the cathode in the present invention, the electrode potential of the cathode during the operation is from +0.6 V to +0.8 V, it is considered that substantially no hydrogen peroxide will be formed as described above. Accordingly, the platinum catalyst and the platinum-cobalt alloy catalyst are considered to be substantially equal in the influence over the durability of the electrolyte membrane.

In the polymer electrolyte fuel cell having the membrane-electrode assembly of the present invention, a gas containing oxygen is supplied to the cathode and a gas containing hydrogen is supplied to the anode. The electrolyte membrane in the present invention plays a role of selectively permeating protons formed in the anode catalyst layer to the cathode catalyst layer along the membrane thickness direction. Further, the electrolyte membrane also has a function as a separating membrane to prevent the hydrogen supplied to the anode and the oxygen supplied to the cathode from being mixed. Such an electrolyte membrane preferably comprises a perfluorocarbon polymer having sulfonic acid groups (which may contain an etheric oxygen atom). Specifically, it is preferably a copolymer containing repeating units based on a perfluorovinyl compound represented by CF₂=CF—(OCF₂CFX)ₘ—Oₚ—(CF₂)ₙ—SO₃H (wherein m is an integer of from 0 to 3, n is an integer of from 1 to 12, p is 0 or 1, and X is a fluorine atom or a trifluoromethyl group) and repeating units based on tetrafluoroethylene.

The above perfluorovinyl compound is preferably compounds represented by the following formulae (i) to (iii). In the following formulae, q is an integer of from 1 to 8, r is an integer of from 1 to 8, and t is an integer of from 1 to 3.
CF₂═CFO(CF₂)_{q}—SO₃H (i)
CF₂═CFOCF₂CF(CF₃)O(CF₂)ᵣ—SO₃H (ii)
CF₂═CF(OCF₂CF(CF₃))ₜO(CF₂)₂—SO₃H (iii)

In a case where the perfluorocarbon polymer having sulfonic acid groups is used, one obtained by fluorination treatment after polymerization and thereby having terminals of the polymer fluorinated may be used. Even when a perfluorocarbon monomer is polymerized, usually the obtained polymer has hydrocarbon groups or hydrocarbon groups containing oxygen on its terminals by the influences of the polymerization initiator, the solvent, etc. When the terminals of the polymer are fluorinated, more excellent stability against hydrogen peroxide and peroxide radicals will be achieved, whereby the durability will improve.

The ion exchange resin contained in the catalyst layers of the anode and the cathode may be the same as or different from the resin constituting the electrolyte membrane, and is preferably a perfluorocarbon polymer having sulfonic acid groups (which may contain an etheric oxygen atom) as same as the electrolyte membrane.

The following process may, for example, be mentioned as a process for producing the membrane-electrode assembly of the present invention. First, coating liquids for forming catalyst layers containing a catalyst powder and an ion exchange resin are prepared and directly applied on a polymer electrolyte membrane, and a dispersion medium contained in the coating liquids is dried and removed to form catalyst layers, which are sandwiched between gas diffusion layers. The gas diffusion layers are disposed outside the membrane-electrode assembly and constitute the anode and the cathode together with the catalyst layers, and they are usually made of carbon paper, carbon cloth, carbon felt or the like.

Otherwise, a process may be employed wherein the coating liquids for forming catalyst layers are applied on substrates to be gas diffusion layers and dried to form catalyst layers, which are bonded to a polymer electrolyte membrane by e.g. hot pressing. Further, a process may also be employed wherein the coating liquids for forming catalyst layers are applied to films which have sufficient stability against the solvent contained in the coating liquids for forming catalyst layers and dried, and the films are hot pressed to a polymer electrolyte membrane, and then the substrate films are separated, and the polymer electrolyte membrane is further sandwiched between gas diffusion layers.

In the polymer electrolyte fuel cell provided with the membrane-electrode assembly according to the present invention, for example, a separator having grooves formed to constitute gas flow paths is disposed outside of each electrode of the membrane-electrode assembly, and the gas containing hydrogen and a gas containing oxygen are permitted to flow through the gas flow paths to the anode and to the cathode, respectively, thereby to supply the gases as a fuel to the membrane-electrode assembly to generate the power. Each feed gas is supplied usually as humidified, but may be supplied without humidified in some cases.

Now, the present invention will be described in further detail with reference to Examples and Comparative Examples. However, it should be understood that the present invention is by no means restricted to such specific Examples.

### EXAMPLE 1

Using a commercially available catalyst having a platinum-cobalt alloy supported on carbon (molar ratio of platinum to cobalt 3:1, specific surface area of carbon carrier: 800 m²/g, metal carriage ratio: 52%), 5.1 g of distilled water was mixed with 1.0 g of this catalyst. With this liquid mixture, 5.6 g of a liquid having a CF₂═CF₂/CF₂═CFOCF₂CF(CF₃)O(CF₂)₂SO₃H copolymer (ion exchange capacity: 1.1 meq/g dry polymer) dispersed in ethanol and having a solid content concentration of 9 mass% (hereinafter referred to as liquid A) was mixed. This mixture was homogenized by using a homogenizer (Polytron, trade name, manufactured by Kinematica Company) to obtain coating fluid B for forming a catalyst layer.

This coating fluid B was applied by a bar coater on a substrate film made of polypropylene and then dried for 30 minutes in a dryer at 80° C. to obtain catalyst layer B. Here, the mass of the substrate film alone before formation of the catalyst layer and the mass of the substrate film after formation of the catalyst layer were measured to determine the amount of platinum per unit area contained in the catalyst layer B, whereupon it was 0.2 mg/cm².

Similarly, 5.1 g of distilled water was mixed with 1.0 g of a catalyst powder having platinum supported on a carbon carrier (specific surface area: 800 m²/g) so that platinum was contained in an amount of 50% of the total mass of the catalyst. With this liquid mixture, 5.6 g of the liquid A was mixed. The mixture was homogenized by using a homogenizer (Polytron, trade name, manufactured by Kinematica Company) to prepare coating fluid C for forming a catalyst layer.

This coating fluid C was applied by a bar coater on a substrate film made of polypropylene and then dried for 30 minutes in a dryer at 80° C. to obtain catalyst layer C. In preparation of the catalyst layer, the application amount was controlled so that the amount of platinum per unit area contained in the catalyst layer would be 0.2 mg/cm².

Then, using, as a polymer electrolyte membrane, an ion exchange membrane having a thickness of 50 μm, made of a perfluorocarbon polymer having sulfonic acid groups (Flemion, trade name, manufacture by Asahi Glass Company, Limited, ion exchange capacity: 1.1 meq/g dry polymer) in a size of 5 cm×5 cm (area 25 cm²), the catalyst layers B and C were disposed on both sides of the membrane so that the catalyst layer B was on the anode side and the catalyst layer C was on the cathode side, and the respective catalyst layers were transferred to the membrane by hot press method to prepare a membrane-catalyst layer assembly. The electrode area was 16 cm².

The obtained membrane-catalyst layer assembly was interposed between two gas diffusion layers made of carbon cloth having a thickness of 350 μm to prepare a membrane-electrode assembly, which was assembled into a cell for power generation, and an open circuit voltage test (OCV test) was carried out as an accelerated test. In the test, hydrogen (utilization ratio: 70%) and air (utilization ratio: 40%) corresponding to a current density of 0.2 A/cm² were supplied under ordinary pressure to the anode and to the cathode, respectively, the cell temperature was set at 90° C., the dew point of the anode gas was set at 60° C. and the dew point of the cathode gas was set at 60° C., the cell was operated for 100 hours in an open circuit state without generation of electric power, and a voltage change was measured during the period. Furthermore, by supplying hydrogen to the anode and nitrogen to the cathode, amounts of hydrogen gas having leaked from the anode to the cathode through the membrane were analyzed before and after the test, thereby to check the degree of degradation of the membrane. The results are shown in Table 1.

### EXAMPLE 2

A membrane-catalyst layer assembly was obtained in the same manner as in Example 1 except that the catalyst layer B was used for the cathode catalyst layer so that both the cathode and the anode were constituted by the catalyst layer B. This membrane-catalyst layer assembly was used to obtain a membrane-electrode assembly in the same manner as in Example 1, and an open circuit voltage test was carried out in the same manner as in Example 1. The results are shown in Table 1.

### EXAMPLE 3

### Comparative Example

A membrane-catalyst layer assembly was obtained in the same manner as in Example 1 except that the catalyst layer C was used for the anode catalyst layer so that both the cathode and the anode were constituted by the catalyst layer C. This membrane-catalyst layer assembly was used to obtain a membrane-electrode assembly in the same manner as in Example 1, and an open circuit voltage test was carried out in the same manner as in Example 1. The results are shown in Table 1.

### EXAMPLE 4

### Comparative Example

A membrane-catalyst layer assembly was obtained in the same manner as in Example 1 except that the anode catalyst layer in Example 2 was changed to the catalyst layer C so that the cathode was constituted by the catalyst layer B and the anode was constituted by the catalyst layer C. This membrane-catalyst layer assembly was used to obtain a membrane-electrode assembly in the same manner as in Example 1, and an open circuit voltage test was carried out in the same manner as in Example 1. The results are shown in Table 1.

TABLE 1

| | | | Open circuit | | Hydrogen leak | |
|---|---|---|---|---|---|---|
| | | | voltage (V) | | (ppm) | |
| | | | | After | | After |
| | Cathode | Anode | | 100 | | 100 |
| | catalyst | catalyst | Initial | hours | Initial | hours |
| Ex. 1 | Pt | Pt—Co | 0.98 | 0.97 | 710 | 720 |
| Ex. 2 | Pt—Co | Pt—Co | 0.99 | 0.97 | 700 | 710 |
| Ex. 3 | Pt | Pt | 0.98 | 0.75 | 700 | 15,000 |
| Ex. 4 | Pt—Co | Pt | 0.99 | 0.71 | 720 | 18,000 |

Then, each of the membrane-catalyst layer assemblies obtained in Examples 1 to 4 is interposed between two gas diffusion layers made of carbon cloth having a thickness of 350 μm and assembled into a cell for power generation, and a durability test under operation conditions under low humidification is carried out. The test conditions are as follows. Hydrogen (utilization ratio: 70%) /air (utilization ratio: 40%) is supplied under ordinary pressure at a cell temperature at 80° C. and at a current density of 0.2 A/cm², and the polymer electrolyte fuel cell is evaluated as to the initial property and durability. Hydrogen and air are so humidified and supplied into the cell that the dew point on the anode side is 80° C. and that the dew point on the cathode side is 60° C., respectively, whereupon the cell voltage at the initial stage of the operation and the relation between the elapsed time after the initiation of the operation and the cell voltage are measured. The results are shown in Table 2. In addition, the cell voltage at the initial state of the operation and the relation between the elapsed time after the initiation of the operation and the cell voltage are also measured in the same manner as above under the above cell evaluation conditions except that the dew point on the cathode side is changed to 80° C. The results are shown in Table 3.

TABLE 2

Durability/output voltage (V)

| | Initial output | After 500 | After 2,000 |
|---|---|---|---|
| | voltage (V) | hours | hours |
| Ex. 1 | 0.74 | 0.73 | 0.72 |
| Ex. 2 | 0.75 | 0.74 | 0.74 |
| Ex. 3 | 0.74 | 0.68 | 0.62 |
| Ex. 4 | 0.75 | 0.69 | 0.64 |

TABLE 3

Durability/output voltage (V)

| | Initial output | After 500 | After 2,000 |
|---|---|---|---|
| | voltage (V) | hours | hours |
| Ex. 1 | 0.75 | 0.74 | 0.73 |
| Ex. 2 | 0.76 | 0.75 | 0.75 |
| Ex. 3 | 0.75 | 0.73 | 0.71 |
| Ex. 4 | 0.76 | 0.73 | 0.72 |

As shown in Examples, when a platinum catalyst is used for the anode catalyst, in an open circuit voltage test (OCV test) at high temperature which is an accelerated test under low humidification conditions, the electrolyte membrane was deteriorated, and the hydrogen leak increased, whereas by use of a platinum-cobalt alloy catalyst for the anode catalyst as in the present invention, it is confirmed that deterioration of the electrolyte membrane can be suppressed. Further, the membrane-electrode assembly of the present invention is sufficiently excellent in the durability even under high humidification conditions. Therefore, according to the present invention, a membrane-electrode assembly for a polymer electrolyte fuel cell excellent in the durability either in operation under high humidification conditions or in operation under low humidification conditions, can be provided.

The entire disclosure of Japanese Patent Application No. 2005-301752 filed on Oct. 17, 2005 including specification, claims and summary is incorporated herein by reference in its entirety.

What is claimed is:

1. A membrane-electrode assembly for a polymer electrolyte fuel cell, which comprises an anode and a cathode each having a catalyst layer containing a catalyst powder and an ion exchange resin, and an electrolyte membrane made of an ion exchange membrane disposed between the anode and the cathode, characterized in that the catalyst layer of the anode contains a catalyst powder having a platinum-cobalt alloy supported on a carbon carrier.

2. The membrane-electrode assembly for a polymer electrolyte fuel cell according to claim 1, wherein the catalyst layer of the anode contains from 0.05 to 5 mg/cm² of platinum atoms per apparent surface area.

3. The membrane-electrode assembly for a polymer electrolyte fuel cell according to claim 1, wherein the platinum-cobalt alloy contains platinum and cobalt in a molar ratio of from 6:1 to 2:1.

4. The membrane-electrode assembly for a polymer electrolyte fuel cell according to claim 1, wherein the carbon carrier has a specific surface area of from 30 to 1,000 m²/g.

5. The membrane-electrode assembly for a polymer electrolyte fuel cell according to claim 1, wherein the ion exchange resin is a copolymer containing repeating units based on a perfluorovinyl compound represented by CF₂═CF—(OCF₂CFX)ₘ—Oₚ—(CF₂)ₙ—SO₃H (wherein m is an integer of from 0 to 3, n is an integer of from 1 to 12, p is 0 or 1, and X is a fluorine atom or a trifluoromethyl group) and repeating units based on tetrafluoroethylene.

6. The membrane-electrode assembly for a polymer electrolyte fuel cell according to claim 5, wherein terminals of the ion exchange resin are fluorinated.

7. The membrane-electrode assembly for a polymer electrolyte fuel cell according to claim 2, wherein the platinum-cobalt alloy contains platinum and cobalt in a molar ratio of from 6:1 to 2:1.

8. The membrane-electrode assembly for a polymer electrolyte fuel cell according to claim 7, wherein the ion exchange resin is a copolymer containing repeating units based on a perfluorovinyl compound represented by CF₂═CF—(OCF₂CFX)ₘ—Oₚ—(CF₂)ₙ—SO₃H (wherein m is an integer of from 0 to 3, n is an integer of from 1 to 12, p is 0 or 1, and X is a fluorine atom or a trifluoromethyl group) and repeating units based on tetrafluoroethylene.
